(19) United States
(12) Patent Application Publication
(10) Pub. No.: US 2013/0092288 A1
(43) Pub. Date: Apr. 18, 2013

(54) DISPENSER AND METHOD FOR DISPENSING FLOWABLE OR POURABLE MATERIALS

(71) Applicant: Armin Schriber, Ruti (CH)

(72) Inventor: Armin Schriber, Ruti (CH)

(73) Assignee: TECAN TRADING AG, Mannedorf (CH)

(21) Appl. No.: 13/696,900

(22) PCT Filed: May 6, 2011
(86) PCT No.: PCT/EP2011/057260

§ 371 Date: Dec. 11, 2012

(30) Foreign Application Priority Data
May 12, 2010 (CH) 00738/10
May 13, 2010 (US) 61334332

(51) Int. Cl. B65B 43/42

(52) U.S. Cl. CPC B67D 7/08; B67D 7/72; B65B 3/36
USPC 141/153; 141/186

(57) ABSTRACT

A dispenser delivering flowable or pourable material has a line for transporting the material from a container to an outlet end of the line. The line, filled with material, has its inlet end in the container or connected to the container. A stop valve controls dispensing of the material from the outlet end and a control controls opening and closing of the valve. The line has an elastic section inserted in the valve and the valve is a pinch valve for the stationary compression of the elastic section and therefore for closure of the line. The control controls an opening time of the valve for delivery of a defined quantity of material into a sample vessel, wherein this opening time is exclusively determined by properties of the material and properties of the line filled with material.

This International Patent Application claims the priority of the Swiss Patent Application No. 00738/10 dated 12 May 2010 and the U.S. Provisional Application No. 61/334,332 dated 13 May 2010. The entire content of these priority applications belongs to the scope of this International application for any purposes.

The invention relates according to the preamble of the independent claim 1 to a dispenser for dispensing flowable or pourable materials. This dispenser comprises at least one line having an inlet end and an outlet end for transporting a flowable material or a pourable material from a container to the outlet end. At the same time, the line can be positioned with its inlet end in the flowable or pourable material of the container or connected to the container, but in each case can be substantially filled with the flowable or pourable material. The dispenser additionally comprises a stop valve for controlling the dispensing of the flowable or pourable material from the outlet end. The dispenser further comprises a control unit which controls an opening and closing of the stop valve. The invention further relates according to the preamble of the independent claim 20 to a corresponding method for dispensing flowable or pourable materials.

It is known to carry out the dispensing of liquids (the dispensing) in a more or less automated manner. The devices generally used for this purpose are designated as dispensers. Depending on the requirement for the precision of the dispensing in regard to the volume to be dispensed, such dispensers have variously complex structures.

In laboratories, for example, in diagnostics institutes or in other biological or biochemical laboratories, the efficiency and reproducibility of routine experiments can be increased appreciably with the aid of automated dispensing processes. However, for such laboratory dispensers very high requirements are typically imposed on the precision of the liquid volume delivered during the dispensing. This is because very expensive reagents are frequently used (e.g. enzymes, dyes etc.) and because the sample volumes to be processed are relatively small (about 0.5 μl to 2 ml). In order to satisfy these high requirements for the precision of the dispensing, the dispensers comprise special pumps with which the delivery of liquid can be largely controlled. Commonly used pumps are, for example, peristaltic pumps or reciprocating pumps. Peristaltic pumps are preferably used for pure dispensers used for less sensitive laboratory processes. Reciprocating pumps on the other hand are built into dispensers and into combined dispensers having an aspirating function which must deliver liquid volumes with very high precision or, in the case of a pipetting device, must also suck in (aspirate) such volumes. All dispensers have in common that the driving force for dispensing the liquid volume is provided by an additional “driving pressure” on the liquid provided by a pump. By incorporating such pumps, however, the dispensers used in laboratories become relatively complex and therefore also expensive.

A dispenser is thus known from the patent specification U.S. Pat. No. 6,063,339 which can dispense liquids in a pre-programmed array very rapidly and with high precision. This dispenser comprises a positive displacement pump which regulates the inflow of the liquid to be dispensed to a dispenser head. A control unit then controls a solenoid valve and thereby the delivery (or portioning) of the liquid through the dispenser head. Such a dispenser can accordingly deliver defined liquid volumes with high precision and speed but this is very complex in its structure.

Other simpler dispensers are also suitable for delivering very small volumes in the nano- or microlitre range. There is known, for example, the so-called “PipeJet” of the IMTEK Institute for Microsystem Technology, Freiburg, Germany (cf. Streule et al. Journal of the Association for Laboratory Automation JALA October 2004: 300-306). In this case, a thin elastic capillary is filled with a liquid by means of capillary force. An actuator strikes on the outer side of this capillary and thus displaces a certain volume of liquid which is ejected from the line in a reproducible manner due to this impact. After retraction of the actuator, the capillary expands elastically again and adopts the initial shape; the capillary is filled again by means of capillary force and is then ready for the next impact. A similar principle if known from the U.S. Pat. No. 5,763,278 of the present applicant. There also a certain volume of liquid is ejected with the aid of an actuator acting externally on an elastic line. However, the line is refilled here with a precision reciprocating pump. This apparatus for delivering volumes in the range of 1-10 μl also differs from the PipeJet in that after complete filling of the line and the dispenser tip (cf. U.S. Pat. No. 5,763,278: FIG. 2), a first quantity of liquid, used only for priming the device and which is to be discarded, is delivered from the dispenser tip with the actuator (cf. U.S. Pat. No. 5,763,278: FIG. 3). The dispenser tip is then brought into the desired delivery position (e.g. above the well of a micro-plate) whereupon the piston of the pump is advanced by precisely the volume to be delivered (cf. U.S. Pat. No. 5,763,278: FIG. 4). The volume of liquid thus defined is then ejected from the dispenser and into the well by a strike with the actuator (cf. U.S. Pat. No. 5,763,278: FIG. 5).

Simply constructed dispensers having substantially lower precision are known, for example, from infusion systems from hospitals (cf. U.S. Pat. No. 3,667,464). In the simplest form, the hydrostatic pressure of the infusion liquid is used as driving force and a desired dropping speed is set by means of a metering valve (e.g. a roller clamp). If the liquid volume decreases, the metering valve must be readjusted manually. However, if the delivery of a constant supply of liquid is required, additional pumps (infusion pumps) are also used in such infusion systems so that the liquid can be delivered in a controlled manner by the additional pressure. Peristaltic pumps are also usually used here.

As has already been indicated above, such simple, gravity-driven dispensers exhibit the problem that as the liquid level of the liquid to be delivered decreases in the container (i.e. with decreasing hydrostatic pressure), the flow rate diminishes. It is additionally known that the hose becomes increasingly deformed by the roller clamp so that from time to time readjustment must be made to maintain a desired flow rate. In order to nevertheless maintain the flow rate, an additional pressure is frequently applied by pumping. This can take place by a pressure being applied directly onto the liquid with the aid of displacement pumps. Alternatively, the pressure can also act on the elastic bag-shaped container it this is stretched, for example by means of springs (cf. FR 2 701 646). In each of the cases described here, however, an additionally produced pressure is superposed on the hydrostatic pressure.

Alternatively, a dispenser configured as a soap dispenser is disclosed in the patent specification EP 0 781 521 B1 in which the hydrostatic pressure itself is kept constant despite decreasing liquid level in order to maintain a uniform flow rate. This is achieved whereby the container with the liquid is carried by an element which responds to weight. As the container empties due to multiple dispensing of a volume of soap, it becomes lighter whereupon the element reacting to weight raises the container. The height of the contains is therefore always matched to the level of the liquid in this container. According to EP 0 781 521, such elements reacting to weight can, for example, be helical springs which are adapted to the weight of the container. However, the volumes delivered by such soap dispensers do not meet any particular requirements for precision in regard to the volume delivered.

According to a first aspect, it is the object of the present invention to provide a dispenser which can deliver flowable or pourable materials with a very high precision and which is nevertheless simple and favourable in structure.

According to a second aspect, it is the object of the present invention to provide an alternative method with which flowable or pourable materials can be delivered with a very high precision.

This object is achieved according to the first aspect with the features of the independent claim 1. The dispenser according to the invention introduced initially is characterised in that the line comprises an elastic section which can be inserted in the stop valve, which completely separates all the parts of the stop valve from the flowable or pourable material, wherein the stop valve is configured as a pinch valve for the stationary compression of this elastic section and therefore for the closure of the line. The dispenser according to the invention is additionally characterised in that the control unit controls a corresponding opening time t of the stop valve for the delivery of a defined, discrete quantity of the flowable or pourable material into a sample vessel, wherein this opening time t is exclusively determined by the properties of the flowable or pourable material to be delivered and the properties of the line substantially filled with these materials.

The object according to the second aspect is achieved with the features of the independent claim 20. The method according to the invention is based on the use of the dispenser according to the invention introduced initially and is characterised in that an elastic section of the line is inserted in the stop valve, wherein this elastic section completely separates all the parts of the stop valve from the flowable or pourable material, and wherein the stop valve is configured as a pinch valve and stationarily compresses this elastic section for the closure of the line. The method according to the invention is additionally characterised in that the control unit controls a corresponding opening time t of the stop valve for the delivery of a defined, discrete quantity of the flowable or pourable material into a sample vessel, wherein this opening time t is exclusively determined by the properties of the flowable or pourable material to be delivered and the properties of the line substantially filled with these materials.

Additional inventive features are obtained in each case from the dependent claims.

The dispenser according to the invention has the following advantages:
A high precision of the delivered quantity of pourable material or the delivered volume of liquid with a simple structure of the material-carrying parts and therefore low equipment costs.
A direct use of containers in which the material to be dispensed is produced, delivered or stored.
Sterile-packed liquids can be processed, i.e. dispensed from simultaneously sterilised containers and lines.
The use of all wetted or contaminatable single components as disposable articles. The risk of cross-contamination can thus be eliminated or at least minimised. Such disposable articles can be finished as consumable material and delivered sterilised.
A flexible structure of the dispenser ensures that different containers, lines and valves can be used as required.
A gentle delivery of liquids is rendered possible so that liquids (suspensions) for example comprising sensitive material such as cells need not be exposed to any additional pressure apart from the locally very limited influence of the closing valve.
The flexibly selectable line lengths and the variously selectable positions of the valve allow a structure having an extremely small dead volume so that cost-effective operation is possible.

The dispenser according to the invention and the method for delivering flowable or pourable materials are now explained in detail with reference to schematic diagrams which show exemplary and preferred embodiments without restricting the present invention. In the figures:

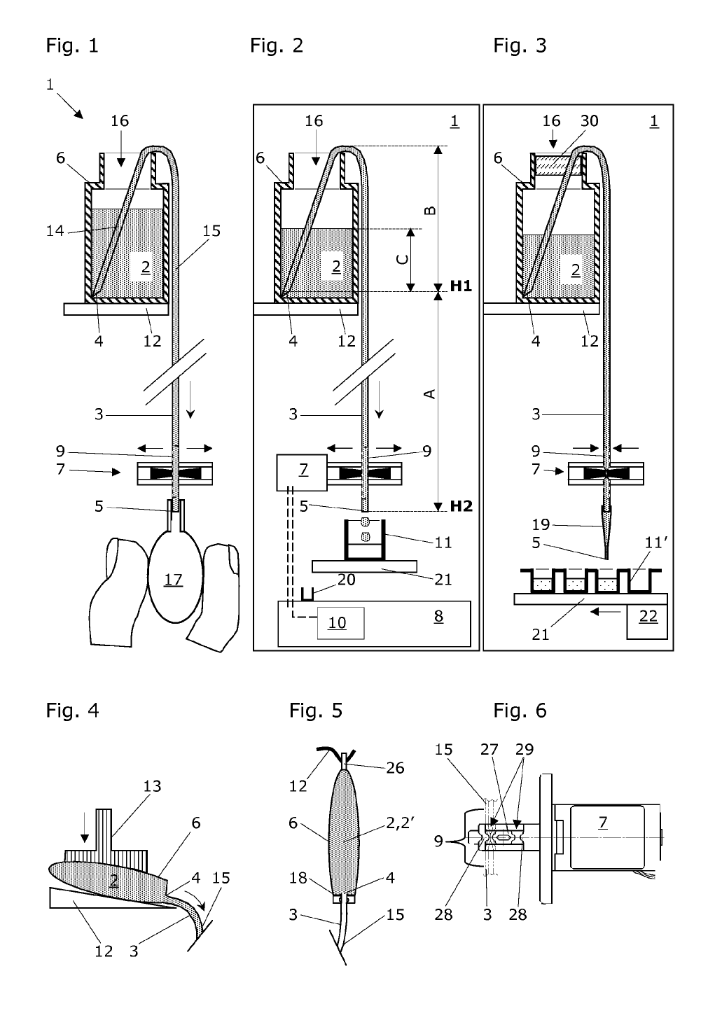

FIG. 1 shows a dispenser according to a first embodiment in which an ascending section of a line is inserted in a standard container for liquids to be dispensed and the descending section is passed through a closing valve, the line being filled when the closing valve is open;

FIG. 2 shows a first variant of the dispenser from FIG. 1 during the controlled delivery of liquid into a single sample vessel;

FIG. 3 shows a second variant of the dispenser from FIG. 1 during the controlled delivery of liquid into wells of a micro-plate;

FIG. 4 shows a container of a dispenser for liquids to be delivered according to a second embodiment comprising a line connected to this container with an exclusively descending part which is designed to be insertable in a closing valve;

FIG. 5 shows a container of a dispenser for liquids to be delivered or pourable solids according to a third embodiment comprising a line which can be inserted into this container with an exclusively descending part which is designed to be insertable in a closing valve;

FIG. 6 shows a side view of a pinch valve with inserted elastic section of the line for transporting the liquids to be delivered or pourable solids;

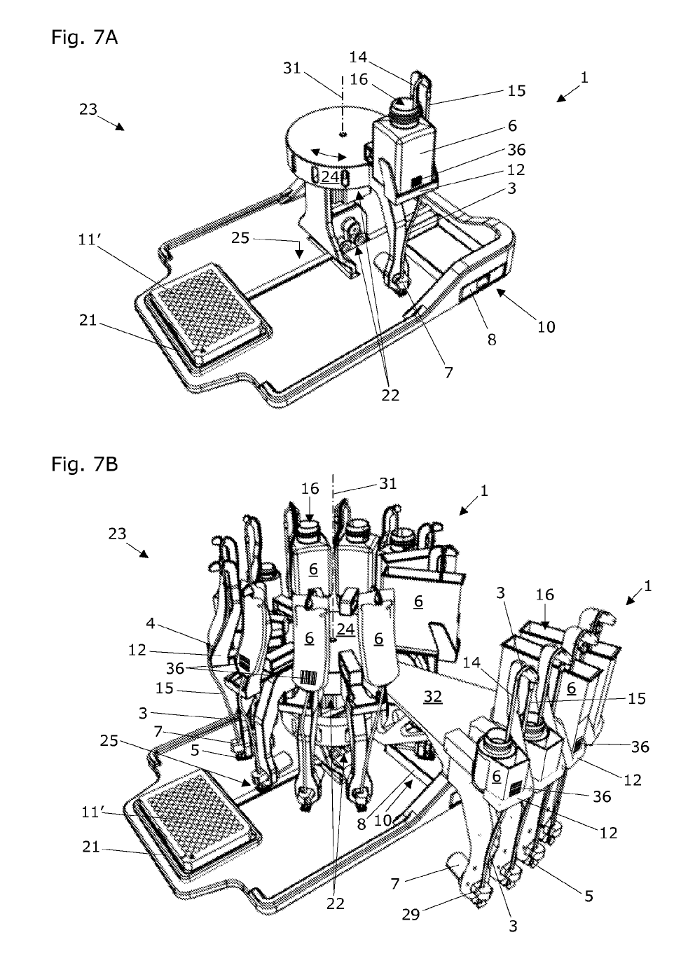

FIG. 7 shows 3D views of dispenser systems, where
FIG. 7A shows a dispenser system having a simple pivoting device on which one or more dispensers are disposed in a circular manner and can be pivoted into a delivery position; and where
FIG. 7B shows a dispenser system having a complex pivoting device on which a plurality of dispensers are disposed in a circular manner and can be pivoted into a delivery position and on which a co-pivoting side arm is mounted on which a plurality of dispensers are fastened in a linear or circular arrangement;

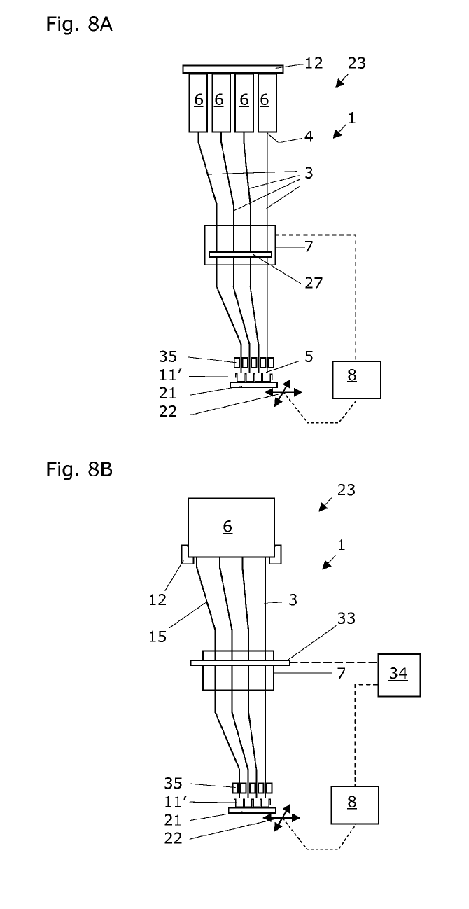

FIG. 8 shows line schemes for the parallel delivery of liquid samples, where
FIG. 8A shows a dispenser system having four parallel channels and individual containers, and
FIG. 8B shows a dispenser system having four parallel channels and a common container.

The dispenser according to the invention is suitable both for delivering liquids and for dispensing pourable solid materials. An important area of application is the dispensing of specific liquid volumes into the wells of micro-plates. The content of such wells is determined according to the geometrical shape of these containers and according to the number of wells per micro-plate. Starting from the SBS Standard (American National Standards Institute: ANSI/SBS/1-2004), the micro-plates have been largely standardised and are available for example from Greiner Bio-One GmbH, D-72636 Frickenhausen, Germany. The following Table 1 shows an extract of standard formats and contents of exemplary polystyrene micro-plates which has been taken from the “Microplate Dimensions Guide” from Greiner (July 2007 Version).

TABLE 1

| | 96 wells | 384 wells | 1536 wells |
|---|---|---|---|
| U-base | AV 40-280 μl | | |
| | MV 323 μl | | |
| V-base | AV 40-200 μl | AV 13-120 μl* | AV 3-15 μl** |
| | MV 234 μl | MV 145 μl* | MV 18 μl** |
| F-base | AV 25-340 μl | AV 10-130 μl | AV 3-10 μl |
| | MV 382 μl | MV 138 μl | MV 12.6 μl |

AV = working volume;
MV = maximum volume
Exceptions:
*polypropylene micro-plate;
**polypropylene deep-well plate

The dispenser according to the invention is particularly suitable for delivering liquid volumes in the range of a few μl to over 100 μl. Special applications however also include the delivery of smaller volumes (in the nanolitre range) or larger volumes (in the millimetre range).

FIG. 1 shows a dispenser according to a first embodiment. This dispenser 1 is equipped for delivering flowable materials 2 and comprises a line 3 having an inlet end 4 and an outlet end 5 for transporting a flowable material 2 from a container 6 to the outlet end 5. The container shown here is for example a bottle containing an original component from an ELISA kit (enzyme-linked immunosorbent assay).

The line 3 is positioned with its inlet end 4 in the flowable material 2 of the container 6 and can be substantially filled with the flowable material 2. The filling or “priming” of the line 3 is shown here. A primer device 17 of the dispenser, in this case a suction bulb was connected to the outlet end 5 of the dispenser 3. As a result of the expansion of the initially-compressed elastic suction bulb, liquid 2 was sucked from the container 6 into the line 3. The liquid is preferably sucked in so far (cf. perpendicular flow arrow) that its meniscus reaches the outlet end 5 of the line 3.

The dispenser 1 additionally comprises a stop valve 7 with which the line 3 can be fixed. Further exemplary possibilities for fastening the line 3 are shown in FIG. 7. This stop valve 7 is used to control the delivery of the flowable material 2 from the outlet end 5 of the line 3 and shown here in the open state. The line 3 comprises an elastic section 9 (indicated by the dashed line here) which can be inserted into the stop valve 7. This elastic section 9 is preferably a part of the line 3; however, the entire line 3 can also be configured to be elastic. In any case, this elastic section 9 completely separates all the parts of the stop valve 7 from the flowable material 2.

The stop valve 7 is configured as a pinch valve for the stationary compression of this elastic section 9 and therefore for the reversible closure of the line 3. A combination of a pinch valve of the type PS-1615-NC (Takasago Electric Inc., Nagoya, Japan) and an elastic silicone line has proved very successful (cf. FIG. 6), where even a repeated pinching (test: 1000×) of the silicone line could not permanently deform this so that a good reproducibility of the delivered quantities was ensured. For disposable articles, i.e. for silicone lines which are used for emptying a container 6 once and then discarded, a maximum number of a few thousand closures is considered to be acceptable. For substantially higher numbers of closures however, a reduction of the elasticity of the line and therefore a change of the opening time for the same delivered volume must be anticipated. The stop valve mentioned here is preferably of the “current-less closed” type and the dimensional stability is given as about 10⁷ cycles. Depending on the requirement, the stop valve 7 can be opened by a specific amount so that the opening of the line either takes place only partially or completely. If the stop valve 7 is only partially opened, this is accomplished with maximum reproducibility preferably by a mechanically defined, adjustable open end position.

It was interestingly found that the priming of the line 3 should not only include the completest possible filling (however, very small air bubbles do not interfere) but also at least one closing, opening (=conditioning, cf. horizontal, diverging arrow) and closing again (pinching, releasing, pinching) of the line 3; only then are the delivered quantities reproducible for the same opening time.

In connection with the present invention, a “discrete quantity” is considered to be a clearly delimited, defined volume.

In connection with the present invention, the expression “priming” designates the first, almost complete filling of the line 3. In this context “almost completely filled” means that smaller gas or air bubbles can be tolerated as long as these do not jeopardise the cohesion of the liquid column formed by the priming in the line 3.

In connection with the present invention, the expression “conditioning” designates the opening and closing of the line 3 (cf. FIG. 2 and FIG. 3). During this opening and re-closing of the elastic section 9 of the line 3, smaller volumes in the microlitre range can also be delivered. This conditioning is preferably executed after the priming and directly before the first dispensing. It is also preferred to carry out such a conditioning step after fairly long idle times of a line 3 (in the range of up to several hours) directly before the next dispensing.

The dispenser 1 furthermore comprises a control unit 8 which controls an opening and closing of the stop valve 7. Such a control unit 8 preferably comprises an actuator for determining the opening time of the stop valve 7. Actuators operatively connected to the control unit 8 are preferably, for example, rotary capacitors, control elements, or a processor which calculates the actual opening time t of the stop valve 7. By this means the control unit 8 controls a corresponding opening time t of the stop valve 7 and thereby the delivery of a defined, discrete quantity of the flowable material 2 that is fed into a sample vessel 11. This opening time t according to the invention is exclusively determined by the properties of the flowable material 2 to be delivered and the properties of the substantially filled line 3.

Software activated in the control unit 8 on the containers 6 preferably uses available identifications for identifying these container, their geometry, content and volume. Such identifications can, for example, by barcodes (e.g. as a barcode or as a 2D code) and/or radio frequency labels (RFID tags). This software is additionally preferably suitable for tracking the liquid level in the containers, i.e. for evaluating the current residual volume remaining in the containers (cf. component C in FIG. 2).

According to the invention, the volume in the bottles (containers 6) containing the ELISA original components should always be determined precisely but briefly. The automatic identification of these containers and their content makes decanting their content unnecessary so that an important source of error (confusions) and losses caused by the decanting can be avoided. The control unit 8 is preferably also configured to track the lowering of the liquid level in the individual (previously identified) containers 6 and to correct the opening times of the valves to the hydrostatic pressure in the container/line combination which is thereby slightly changed. This tracking of the liquid level can be accomplished computationally by reference to the delivered liquid volume. Alternatively the liquid level in the containers can be determined using, for example, optical or capacitive methods.

The properties of the flowable material include, for example the viscosity of a liquid, its vapour pressure, its friction on the inner surface of the line 3 and its specific weight.

The properties of the line include, for example, its geometry (inside diameter, length and height difference) and its material and elasticity (in particular in the section 9 which is inserted in the stop valve 7).

The properties of a substantially filled line 3 include the properties of the flowable material 2 (the hydrostatic pressure prevailing in the line, produced by the liquid) or the pourable material 2′ (the potential energy of the material particles). If liquids are to be delivered, a pressure additionally produced in the container 6 and/or in the line 3 can be superposed on the hydrostatic pressure. In the first embodiment shown in FIG. 1, the ascending section 14 of the line 3 is inserted through an opening 16 into a standard container 6 for liquids to be dispensed. The descending section 15 of this line comprises the outlet end 5 and is guided through the closing valve 7. When the closing valve 7 is opened, the line is filled during priming. The dispenser 1 preferably comprises a retaining device 12 with the aid of which the container 6 with the inlet end 4 of the line 3 can be arranged at a first height level H1 (cf. also FIG. 2). The retaining device 12 is preferably configured for placement of the container 6 such that the inlet end 4 of the line 3 is located as far as possible at the lowest point of the container 6.

FIG. 2 shows a first variant of the dispenser 1 from FIG. 1 during the controlled delivery of liquid 2 into a single sample vessel 11. As before in FIG. 1, the entire line 3 is not shown here and unlike FIG. 1, the entire valve 7 is shown. In this case, the outlet end 5 of the line 3 is located at a second, lower-lying height level H2, where the value A designates the height difference H1−H2. Due to this height difference (H1−H2), a hydrostatic pressure prevails in the line 3 substantially filled with flowable material 2. The hydrostatic pressure is however increased by a value C which is determined by the level of the liquid in the container 6. Consequently, the hydrostatic pressure prevailing in the line 3 is determined independently of the mass B by the sum of the masses A+C. The resulting hydrostatic pressure determines the transporting of the flowable material 2 from the container 6 to the outlet end 5 of the line 3.

The stop valve 7 is disposed here near the outlet end 5 of the line 3. It could however, also be fastened, for example, on the retaining device 12 (not shown). The line 3 preferably comprises a removable stopper 20 which reversibly seals the line at its outlet end 5; this is used to protect the outlet end from contamination when the dispenser 1 is, for example, not specifically in operation. The stopper 20 has been removed here and deposited on a housing which accommodates the control unit 8 and at least one processor 10. At the instant shown the stop valve 7 is open so that a specific volume (here shown in drop form) will shortly again leave the outlet end 5 of the line 3. If, as shown here, the blunt line end is used as outlet end 5, preferably larger volumes in the microlitre or millilitre range are delivered as single drops (≧10 μl) or reproducibly in constant flow (≧100 μl) (C_{V}≦1.6%). In this case, the value C_{V} gives the coefficient of variation; this is calculated using the formula

$$VK = \frac{σ}{\overline{x}} \times 100 \qquad ( 1 )$$

from the quotient of the standard deviation/mean and is usually given in %.

Experimental data from the Reproducibility Test

The following experimental setup was selected to determine this C_{V} value: a container 6 was placed on a retaining device as can be seen from FIG. 2. The current hydrostatic pressure for section A was (H1−H2=17 cm) 17 hPa and for the current liquid level in container 6 (section C) about 8 hPa. This resulted in a total for the effectively active hydrostatic pressure of 25 hPa.

The silicone hose selected as line 3 carried the designation “SF 1303 medical grade 0.062 ID×0.125 AD” (Article No. FT 06 5205 3162, Angst+Pfister AG, Zurich, Switzerland), was 410 mm long and had an inside diameter of 1.6 mm and an outside diameter of 3.2 mm. This line 3 was fastened in the container 6 such that its inlet end 4 was placed near the vessel bottom.

The container 6 contained 100 ml of deionised water that was used as test liquid 2. Before delivering the test volume, a “conditioning dispensation” was delivered for the duration of 80 ms. At the control unit 8 the valve opening time of 110 ms per dispensation was set; in this case the accuracy of the total valve opening time which was controlled in steps of 10 ms was about 1 ms or +/−1%.

Dispensing was carried out into a collecting vessel located on a calibrated analytical balance (SAS 285, Mettler-Toledo, Greifensee, Switzerland) in a room protected from draughts. The experiments were carried out at a room temperature of 21.3° Celsius and a relative humidity of 41%. The following quantities of liquid (specified in mg) were measured:

TABLE 2

| | | | | | | | | | |
|---|---|---|---|---|---|---|---|---|---|
| 51.0 | 51.9 | 50.3 | 51.6 | 52.0 | 50.7 | 52.2 | 51.4 | 52.6 | 50.7 |
| 52.1 | 50.4 | 52.0 | 50.1 | 51.1 | 52.2 | 50.7 | 52.2 | 50.7 | 52.0 |
| 50.5 | 51.4 | 52.3 | 50.9 | 51.6 | 52.3 | 49.9 | 51.5 | 52.1 | 50.4 |
| 51.4 | 51.8 | 50.1 | 51.1 | 52.2 | 50.5 | 51.1 | 52.0 | 50.0 | 51.3 |
| 52.0 | 50.2 | 51.2 | 51.7 | 49.7 | 51.0 | 51.4 | 49.7 | 50.4 | 51.7 |
| 52.2 | 50.6 | 51.6 | 52.0 | 50.2 | 51.2 | 51.7 | 49.9 | 50.9 | 51.5 |
| 49.8 | 50.7 | 51.7 | 49.7 | 50.6 | 51.5 | 49.3 | 50.4 | 51.4 | 52.0 |
| 50.4 | 51.2 | 51.9 | 50.0 | 51.0 | 50.9 | 49.9 | 50.6 | 51.8 | 49.7 |
| 50.8 | 51.6 | 49.6 | 50.6 | 51.4 | 52.1 | 50.6 | 51.3 | 52.0 | 50.2 |
| 51.1 | 51.8 | 50.2 | 50.9 | 51.6 | 49.7 | | | | |

The total amount of liquid delivered in the 96 dispensing actions (about 51 μl each) was 4.896 ml or about 5% of the content of the container 6. The error in the hydrostatic pressure caused by these dispensing processes was therefore about 1/20 of 8 hPa, i.e. 0.4 hPa and was not corrected in the software of the control unit 8. The standard deviation calculated from the data given in Table 2 is 0.80958011, the corresponding mean corresponds to a volume of 51.07395833 μl. Calculated according to the above formula, C_{V} is 1.59%.

The Hagen-Poiseuille law (according to Gotthilf Heinrich Ludwig Hagen, 1797-1884; Jean Louis Marie Poiseuille, 1797-1869) is used as the theoretical basis for the flow rate calculations of the dispenser. The volume flow, i.e. the volume V which has flowed per unit time, in the case of a laminar flow of a homogeneous viscous liquid through a tube (capillary having the radius r and length l) is described as follows using the Hagen-Poiseuille law:

$$\dot{V} = \frac{d V}{d t} = \frac{π {r}^{4}}{8 η} \frac{Δ p}{l} \qquad ( 2 )$$

Where (the units are given in square brackets):
V volume flow through the tube [m³/s]
r inside radius of the tube [m]
l length of the tube [m]
η dynamic viscosity of the flowing liquid [Pa's]
Δ pressure difference between beginning and end of the tube [Pa].

TABLE 3

| | | |
|---|---|---|
| Liquid level above standing surface at | [mm] | 80 |
| start | | |
| Viscosity at 20° Celsius | [mPa s] | 1 |
| Liquid level, outlet to standing | [mm] | 170 |
| surface | | |
| Average inside diameter of line | [mm] | 1.370 |
| Line length | [mm] | 410 |
| Area of line inside cross-section | [m^{2]} | 1.431 × 10⁻⁶ |
| Current pressure difference | [Pa] | 2500 |
| Flow resistance | [kPa/(m³/s)] | 5029315.5 |
| Flow resistance | [kPa/(ml/ms)] | 5029315.5 |
| Flow | [μl/ms] | 0.5368524 |
| Calculated valve activation time for | [ms] | 109.8 |
| 50 μl incl. 15 ms experimentally | | |
| determined time for switching from | | |
| closed to open | | |

Good agreement can be confirmed between the amount of liquid actually delivered per dispensation of 51 μl and the calculated valve activation time. A small deviation is obtained, for example, since a somewhat smaller inside diameter of the line 3 (caused by a slight deformation of the silicone hose in the valve seat 29) was assumed for the calculation.

FIG. 3 shows a second variant of the dispenser 1 from FIG. 1 during the controlled delivery of liquid 2 into wells of a micro-plate 11′. Unlike FIG. 2, a filter 30 is inserted in the opening 16 of the container 6 so that as a result of the suction produced in the container during the delivery of the liquid 2 no contaminating germs can enter into the liquid from the ambient air. As already shown in FIGS. 1 and 2, the closing elements of the valve 7 are arranged here so that the elastic section 9 of the line 3 is stationary, i.e. always at the same place, and is always compressed at the same location. The line 3 here comprises a dispenser tip 10 at its outlet end 5. The dispenser tip 19 preferably comprises a removable stopper 20 which reversibly seals the dispenser tip 19; this serves to protect the outlet end 5 from contamination when the dispenser 1 is not specifically in operation, for example. The stopper 20 has been removed here (not shown). Whereas FIG. 2 shows a single same vessel 11 on a sample holder 21 specially provided for this, here a micro-plate 11′ having a number of 96 flat-bottomed wells was placed on this sample holder 21 or inserted in this sample holder 21. A motorised drive 22 moves the sample holder 21 with the micro-plate 11′ so that specific wells of the micro-plate 11′ and the outlet end 5 of the line or the dispenser tip 19 can be positioned correctly with respect to one another. The positioning of the sample holder 21 and/or the outlet end 5 of the line 3 with respect to one another is preferably accomplished by means of at least one motorised drive 22, the corresponding movements being controlled by the control unit 8 and the processor 10.

It generally holds that the sample vessels 11, 11′ which can be positioned by the sample holder 21 are selected from the group comprising wells of micro-plates, sample tubes and gel cassettes as well as MALDI-TOF mass spectrometry targets (matrix assisted laser desorption/ionization-time of flight) and object slides (for example, for light microscopy). The sample vessels can thus define a specific volume, have only small recesses or even be configured to be completely flat. The flowable material 2 is preferably selected from the group comprising liquids, suspensions, gels and emulsions. At the instant shown the stop valve 7 is closed so that a specific volume (in drop form) specifically leaves the outlet end 5 of the line 3 (not visible). If, as shown here, a dispenser tip 19 is used as outlet end 5, smaller volumes in the nanolitre or microlitre range are preferably delivered reproducibly as single drops (≦10 μl). Instead of a dispenser tip having a small diameter, a hose having a smaller diameter can also be selected for delivering smaller volumes, where its end is simply cut off cleanly and used as “dispenser outlet”. In each case of a delivery of smaller volumes in the nanolitre or microlitre range, the detachment of a drop to be delivered or of a cohesive liquid jet to be delivered is reproducibly accomplished by the closing impulse of the stop valve 7. This effect of an impulse on the line 3 is known in similar manner from U.S. Pat. No. 5,763,278. Due to a multiple delivery of individual drops or due to the provision of a liquid jet made possible by means of longer opening times of the stop valve 7, however, larger quantities of liquids can also be reproducibly delivered.

FIG. 4 shows a container 6 of a dispenser 1 for liquids to be delivered according to a second embodiment. The container 6 comprises a line 3 connected to this container with an exclusively descending section 15 which is designed to be insertable into a closing valve 7. This container 6 is here a plastic bag such as is used, for example, in hospitals for infusions. The retaining device 12 should be mounted around the container 5 somewhat at a slope so that the inlet end 4 of the line 3 is located at the lowest point of the bag-shaped container 6. In addition, a simple pressure device 13 (in the form of a weight placed on the bag) is shown here. With this pressure device 13 an excess pressure is produced in the container 6 containing the flowable material 2 or in the line 3.

This weight should therefore be superposed on the hydrostatic pressure already prevailing and on the one hand contribute to an even more precise delivery of liquid. In this case, an ideal set pressure is preferably produced for each individual container/line combination (with or without dispenser tip). The ideal set pressure is, for example, influenced by a provided volume to be delivered, the properties of the liquid to be delivered (vapour pressure, viscosity, specific weight etc.) and the properties of the line 3. On the other hand, the pressure in a container/line combination can be increased in order to deliver the same volume of liquid in a shorter time.

Alternatively, for example, a motor-driven punch can be pressed onto the bag (not shown). It can also be provided to place a bag between two surfaces, where at least one of these two surfaces is pressed against the other surface (clamp or press, not shown). It can also be provided that the line 3 is formed from the flexible container 6 (bag) at least partially as an ascending line (not shown).

FIG. 5 shows a container 6 of a dispenser 1 for liquid 2 to he delivered or pourable solids 2′ according to a third embodiment. The container 6 is configured as a plastic bag in which a line 3 is inserted. This line comprises an exclusively descending section 15 which is designed to be insertable in a closing valve 7. The retaining device 12 is here configured as a suspending hook which engages in a suspension eye 26 of the container 6. The inlet end 4 of the line 3 pierces a membrane 18 which otherwise terminates the container 6. In the event that the container 6 contains exclusively pourable material 2′, this is preferably selected from the group comprising powder, grains, spheres and comminuted solids. Due to the height difference H1−H2 (cf. FIG. 2), the pourable material 2′ has a potential energy in the line 3 substantially filled with said material which determines the transporting of the pourable material 2′ from a container 6 to the outlet end 5 of the line 3. Container 6 and lines 3 as shown in FIGS. 1 to 3 or bags and lines as shown in FIGS. 5 and 6, regardless of whether these are separable from one another or not, are preferably formed as plastic disposable articles. Glass containers are preferably also treated as disposable articles to eliminate cross contamination as far as possible.

FIG. 6 shows a side view of a pinch valve of the type PS-1615-NC with inserted elastic section of the silicone line 3 for transporting the liquids 2 to be delivered or pourable solids 2′. The diameter of the silicone line 3 is preferably 3.2 mm on the outside and 1.6 mm on the inside and the permissible working pressure is 0 to 1.5 bar. In this pinch valve 7 only a slider 27 driven by an electric coil is moved to and fro. The elastic section 9 of the line 3 is inserted in one of the two seats 29 so that the slider 27 in an end position presses this line 3 against a fixed counterpiece 28. In the other end position of the slider 27 (not shown), the line 3 is open. After removing the line 3, as required, the part of the valve 7 with the two counterpieces 28 and the slider 27 can be dismounted and replaced by new replacement parts which are uncontaminated or show no wear, with the two counterpieces 28 and the slider 27.

FIG. 7 shows 3D views of dispenser systems 23 comprising at least one, but preferably comprising at least two of the previously described dispensers 1. Such a dispenser system 23 preferably comprises at least two lines 3 each having an inlet end 4, outlet end 5 and elastic section 9; two stop valves 7 configured as pinch valves for insertion of the elastic sections 9 of the lines 3; and a control unit 8 comprising a processor 10 for calculating the opening time t of the stop valves 7 and for controlling these stop valves 7. At the same time, each outlet end 5 of the lines 3 preferably comprises a dispenser tip 19, wherein these dispenser tips 19 can be arranged in a row or in a circle.

Such a dispenser system 23 preferably comprises a pivoting device 24 with which each dispenser tip 19 with the outlet end 5 of a line 3 in this dispenser system 23 can be pivoted into a specific delivery position 25. Alternatively it is preferred that the dispenser tips 19 at the outlet ends 5 of the lines 3 in this dispenser system 23 can be arranged linearly at a distance from one another, wherein this distance corresponds to the axial distance of wells of a micro-plate 11′.

FIG. 7A shows a dispenser system with a simple pivoting device 24 on which a plurality of dispensers 1 are arranged in a circle and can be pivoted into a delivery position 25. A mounted dispenser 1 as depicted in FIG. 2 is shown. This dispenser 1 can be rotated with the pivoting device 24 about a central axis 31, wherein the pivoting device 24 can be moved by means of a motorised drive 22. The sample holder 21 with the micro-plate 11′ can also be moved linearly here by means of a motorised drive 22. Specific wells can thus be positioned under the dispenser tip 19 which is located specifically in the delivery position 25. These movements are preferably controlled and monitored by the control unit 8 or by the processor 10 or another computer.

The container 6 shown is a liquid container available on the market and preferably comprises an identification 36 in the form of a barcodes (preferably as a barcode or as a 2D barcode). For reading this identification a dispenser system 23 comprises a corresponding reading device (not shown) which relays the read-out information to the control unit 8. The control unit 8 thus knows at any time which liquid is present in the container 6 so that stored physical characteristic data can be accessed and the dispensing process can be modified accordingly (preferably automatically). At the same time the control unit 8 knows the initial volume present in the container 6 and (because the control unit 8 controls the dispensing) also the actual volume of the liquid 2 in the container 6.

FIG. 7B shows a dispenser system 23 with a complex pivoting device 24 on which a plurality of dispensers 1 are arranged in a circle and can be pivoted into a delivery position 25. In addition, a co-pivoting side arm 32 is mounted on this pivoting device 24 on which a plurality of dispensers 1 are fastened in a linear (not shown) or circular arrangement (shown). If the dispensers 1 of the side arm 32 are arranged linearly, a plurality of wells of a micro-plate 11′ can be filled simultaneously. All the other elements correspond to the diagram in FIG. 7A.

On the pivoting device 24, eleven containers 6 are arranged substantially in a circle. Four of these containers 6 are bags which are suspended in their suspension eye 26 (cf. FIG. 8) on a clip of the retaining device 12 (cf. front side of the pivoting device), the outlet end 5 of the line 3 of one of these bags being located near the delivery position 25. Two of these containers 6 disposed on the pivoting device 24 are bottles having an original component from an ELISA kit (cf. left side of pivoting device). Three of these containers are other commercially available liquid containers having opened screw tops (cf. rear side of the pivoting device) and two of these containers are trays (cf. right side of the pivoting device) such as are usually used in automatic pipetting systems of liquid handling systems such as for example in the Freedom EVO® of the present applicant. Two of the containers 6 disposed on the side arm 32 are also bottles having an original component from an ELISA kit with opened screw top. All the other elements correspond to the diagram in FIG. 7A.

All the containers 6 shown preferably comprise an identification 36 in the form of a barcode (preferably as a barcode or as a 2D barcode) and/or in the form of an RFID label (=radio frequency identification tag). This was symbolised in FIG. 7B by at least one container of the different types of containers being shown with identification 36 applied or disposed on the container 6. At the same time the alignment of the identifications which are read out optically must advantageously be placed so that all these identifications 36 are arranged at substantially the same height and therefore, for example by rotating the pivoting device, are easily readable. The identification is arranged vertically or horizontally according to the scanning direction of the optical reading device. Since RFID labels are not read out optically, these identifications 36 can be arranged arbitrarily on the containers 6.

FIGS. 7A and 7B show impressively how most diverse containers 6 (in the form of bags, bottles or trays) can be held with identical or only slightly modified retaining devices 12 of the dispenser system 23 according to the invention.

Departing from the representation in FIGS. 1 to 7 but still pertaining to the scope of the present invention, it can be provided that a plurality of lines 3 are disposed with their inlet ends 4 in a common container 6 or are connected to this common container 6 (cf. FIG. 8B).

FIG. 8 shows line diagrams for the parallel delivery of liquid samples. The outlet ends 5 of the lines 3 are preferably arranged so that these have an average distance from one another which precisely corresponds to the axial distance of the wells of a standard micro-plate. Exemplary embodiments with a micro-plate 11′ having 384 flat-bottomed wells are shown here. These micro-plates 11′ are disposed on a sample holder 21 which can be moved in a motorised manner substantially horizontally preferably in an X direction and in a Y direction (cf. arrows in FIGS. 8A and 8B). These movements are preferably controlled by means of the control unit 8 of the dispenser system 23 which controls the delivery of the liquid samples from the containers 6. Such a control unit particularly preferably comprises a processor with corresponding software. Not only the outlet ends 5 of the lines 3 are arranged parallel here, also the opening and closing of these lines 3 here takes place synchronously via a common stop valve 7. Although specifically four lines 3 are operated with one stop valve 7, the number of lines 3 per stop valve 7 can be larger or smaller.

FIG. 8A shows a dispenser system 23 with four parallel channels (lines 3) and four individual containers 6. These containers 6 are each preferably configured as bags and are suspended in respectively one hook of the retaining device 12. Such commercially available bags comprise, for example, a bag wall of a laminate whose innermost layer is made of polypropylene and/or polyethylene. The laminate preferably comprises an aluminium layer as light protection for sensitive liquids.

The lines 3 are guided through the valve 7 such that an individual slider 27 can pinch the elastic sections 9 thereof (not marked here, see FIG. 3) in a closing manner. The stop valve 7 is preferably operatively connected to the control unit 8 so that its opening time can be controlled by the control unit 8. The outlet ends 5 of the lines 3 are held by means of a guide 35 in the vicinity of the outlet ends 5 in a straight line so that their average distance from one another corresponds to the distance of the wells of the 384-well micro-plate of 4.5 mm.

FIG. 8B shows a similar dispenser system 23 with four parallel channels (lines 3) but with a single common container 6 which rests on a retaining device 12. The inlet ends 4 of the lines 3 are let in the base of the container 6 and the descending sections 15 of the lines 3 are also guided through a common stop valve 7 and held near its outlet end 5 by a guide 35.

Unlike FIG. 8A, the closing element of this stop valve 7 is an elastic line 33 which can be pressurised by a pressure unit 34 such that the elastic line 33 expands and pinches together the elastic sections 9 of the lines 3. Such a pressure unit 34 comprises, for example, a pump, a pressure container and a valve (all not shown). This pressure unit 34 is also operatively connected to the control unit 8 so that the opening time of this pinch valve 7 can be regulated and controlled as already described. The control unit 8 is preferably always fitted with a processor 10.

It can be provided to equip at least one dispenser 1 or an entire dispenser system 23 with magnetic stirrers. Such magnetic stirrers are known to the person skilled in the art per se and are used, for example, to keep particles (e.g. living cells) present in liquids in suspension. Alternative means for maintaining suspensions such as, for example, seesawing, can be provided alternatively or additionally to the magnetic stirrers. magnetic stirrers are preferably used in bottle-shaped containers 6 whereas seesawing is more suitable when using containers 6 in the form of horizontal bags. The control unit 8 (with or without processor 10) is preferably used for driving the magnetic stirrer and/or seesawing.

Several possibilities can be considered for monitoring, calibrating and/or aligning the dispensed quantity of liquid using a dispenser 1 or dispenser systems 23 according to the invention, where the corresponding measuring devices can be arranged adjacent to, on or under the sample vessels 11/micro-plates 11′ or under their supports:

### A. Gravimetric Monitoring, Calibration, Alignment

This can be accomplished using a weighing cell as was used in the reproducibility test described above.

### B. Capacitive Monitoring, Calibration, Alignment

The delivered liquid drop or jet is collected in the sample vessel 11 or in the well of a micro-plate 11′, where it disturbs or varies the electric field of a capacitive circuit. The intensity of this disturbance or variation is proportional to the dispensed volume of liquid.

### C. Optical Monitoring, Calibration, Alignment

The delivered liquid drop or jet is monitored optically in flight between outlet end 5 and sample vessel upper edge (e.g. by means of a CCD). By this means the stop time of the opening time of the stop valve 7 is determined for the run time for the desired volume. This is accomplished by means of a processor which converts the shadow of the liquid which has already passed the CCD sensor into a corresponding volume. In addition to the fixed influential parameters, the variable environmental influences are also continuously recorded so that device parameters can preferably be corrected immediately. A delivery monitoring or a self-correcting delivery control is thus provided.

### D. Acoustic Monitoring, Calibration, Alignment

The delivered liquid drop or jet is collected in the sample vessel 11 or in the well of a micro-plate 11′, where it varies the acoustic signal of an ultrasound source circuit. The intensity of this variation is proportional to the dispensed volume of liquid.

In the figures the same reference numbers always designate the same or corresponding elements even if this is not described in detail in each case. Combinations of the disclosed and discussed embodiments pertain to the scope of the present invention.

### REFERENCE NUMBERS

1 Dispenser
2 Flowable material
2′ Pourable material
3 Line
4 Inlet end
5 Outlet end
6 Container
7 Stop valve
8 Control unit
9 Elastic section of 3
10 Processor
11 Sample vessel
11′ Micro-plate
12 Retaining device
13 Pressure device
14 Ascending section of 3
15 Descending section of 3
   16 Opening of 6
17 Primer device
18 Membrane of 6
19 Dispenser tip
20 Stopper
21 Sample holder
22 Motorised drive
23 Dispenser system
24 Pivoting device
25 Delivery position
26 Suspension eye
28 Counterpiece
29 Seat of 9
30 Filter
31 Central axis
32 Side arm
33 Elastic control line
34 Pressure unit
35 Guide
36 Identification
H1 First height level
H2 Second lower-lying height level
A Height difference between H1 and H2
B Height of container
C Fill level of container

1. A dispenser (1) for delivering flowable or pourable materials (2) which comprises:
(a) a line (3) having an inlet end (4) and an outlet end (5) for transporting a flowable material (2) or a pourable material (2′) from a container (6) to the outlet end (5), wherein the line (3) can be positioned with its inlet end (4) in the flowable or pourable material (2, 2′) of the container (6) or connected to the container, but in each case can be substantially filled with the flowable or pourable material (2, 2′);
(b) a stop valve (7) for controlling the dispensing of the flowable or pourable material (2, 2′) from the outlet end (5); and
(c) a control unit (8) which controls an opening and closing of the stop valve (7), characterised in that the line (3) comprises an elastic section (9) which can be inserted in the stop valve (7), which completely separates all the parts of the stop valve (7) from the flowable or pourable material (2, 2′), wherein the stop valve (7) is configured as a pinch valve for the stationary compression of this elastic section (9) and therefore for the closure of the line (3),
and that the control unit (8) controls a corresponding opening time (t) of the stop valve (7) for the delivery of a defined, discrete quantity of the flowable or pourable material (2, 2′) into a sample vessel (11), wherein this opening time (t) is exclusively determined by the properties of the flowable or pourable material (2, 2′) to be delivered and the properties of the line (3) substantially filled with these materials (2, 2′).

2. The dispenser (1) according to claim 1, characterised in that the control unit (8) is operatively connected to a processor (10) which calculates the opening time (t) of the stop valve (7).

3. The dispenser (1) according to claim 1, characterised in that it comprises a retaining device (12) with the aid of which the container (6) can be disposed with the inlet end (4) of the line (3) at a first height level (H1).

4. The dispenser (1) according to claim 3, characterised in that the outlet end (5) of the line (3) can be disposed at a second, lower-lying height level (H2).

5. The dispenser (1) according to claim 4, characterised in that due to the sum of the height differences (A+C) a hydrostatic pressure prevails in the line (3) substantially filled with flowable material (2) which determines the transporting of a flowable material (2) from a container (6) to the outlet end (5) of the line (3).

6. The dispenser (1) according to claim 1, characterised in that it comprises a pressure device (13) whereby an excess pressure can be generated in the container (6) containing the flowable material (2) or in the line (3).

7. The dispenser (1) according to claim 1, characterised in that the stop valve (7) is disposed near the outlet end (5) of the line (3).

8. The dispenser (1) according to claim 1, characterised in that the line (3) comprises an ascending section (14) with the inlet end (4) and a descending section (15) with the outlet end (5), wherein the ascending section (14) can be inserted through an opening (16) of the container (6) into the same.

9. The dispenser (1) according to claim 8, characterised in that it comprises a primer device (17) for the first and substantially complete filling of the line (3) with flowable material (2).

10. The dispenser (1) according to claim 4, characterised in that due to the height difference (H1−H2) the pourable material (2′) in the line (3) substantially filled with said material has a potential energy which determines the transport of the pourable material (2′) from a container (6) to the outlet end (5) of the line (3).

11. The dispenser (1) according to claim 1, characterised in that the line (3) comprises a descending section (15) with the inlet end (4) and the outlet end (5), wherein the inlet end (4) can be inserted through an opening (16) or membrane (18) of the container (6) into the same or is connected to said container (6).

12. The dispenser (1) according to claim 1, characterised in that the line (3) or a combination of line (3) and container (6) are made of plastic disposable articles.

13. The dispenser (1) according to claim 1, characterised in that the line (3) comprises a dispenser tip (19) at its outlet end (5).

14. The dispenser (1) according to claim 2, characterised in that it comprises a sample holder (21) for positioning one or more sample vessels (11), wherein this sample holder (21) and/or the outlet end (5) of the line (3) are configured to be movable relative to one another by means of at least one motorised drive (22), wherein the corresponding movements are controlled by the control unit (8) and the processor (10).

15. A dispenser system (23) comprising at least one dispenser (1) according to claim 1, characterised in that the dispenser system (23) at least comprises:
(a) two lines (3) each having an inlet end (4), outlet end (5) and elastic section (9);
(b) at least one stop valve (7) configured as a pinch valve for inserting the elastic sections (9) of the lines (3); and
(c) a control unit (8) with a processor (10) for calculating the opening time (t) of the stop valves (7) and for controlling these stop valves (7).

16. The dispenser system (23) according to claim 15, characterised in that the outlet ends (5) of the lines (3) can be disposed in a straight line or in a circle.

17. The dispenser system (23) according to claim 15, characterised in that each outlet end (5) of the lines (3) comprises respectively one dispenser tip (19).

18. The dispenser system (23) according to claim 15, characterised in that it comprises a pivoting device (24) with which each dispenser tip (19) with the outlet end (5) of a line (3) in this dispenser system (23) can be pivoted into a specific delivery position (25).

19. The dispenser system (23) according to claim 16, characterised in that the dispenser tips (19) at the outlet ends (5) of the lines (3) in this dispenser system (23) can be arranged linearly at a distance from one another, wherein this distance corresponds to the axial distance of wells of a standard micro-plate (11′).

20. A method for delivering flowable or pourable materials (2) using a dispenser (1) which at least comprises:
(a) a line (3) having an inlet end (4) and an outlet end (5) for trans-porting a flowable material (2) or a pourable material (2′) from a container (6) to the outlet end (5), wherein the line (3) can be positioned with its inlet end (4) in the flowable or pourable material (2, 2′) of the container (6) or connected to the container, but in each case can be substantially filled with the flowable or pourable material (2, 2′);
(b) a stop valve (7) for controlling the dispensing of the flowable or pourable material (2, 2′) from the outlet end (5); and
(c) a control unit (8) which controls an opening and closing of the stop valve (7), characterised in that an elastic section (9) of the line (3) is inserted in the stop valve (7), wherein this elastic section (9) completely separates all the parts of the stop valve (7) from the flowable or pourable material (2, 2′), and wherein the stop valve (7) is configured as a pinch valve and stationarily compresses this elastic section (9) for the closure of the line (3),
and that the control unit (8) controls the delivery of a defined, discrete quantity of the flowable or pourable material (2, 2′) into a sample vessel (11), wherein this opening time (t) is exclusively determined by the properties of the flowable or pourable material (2, 2′) to be delivered and the properties of the line (3) substantially filled with these materials (2, 2′).

21. The method according to claim 20, characterised in that prior to the delivery of a flowable material (2) with this dispenser (1) the line (3) is substantially completely filled with flowable material (2) by means of a primer device (17).

22. The method according to claim 20, characterised in that for the delivery of a defined, discrete quantity of the flowable or pourable material (2, 2′) a corresponding opening time (t) of the stop valve (7) is calculated by means of a processor (10) operatively connected to the control unit (8).
